(19) United States
(12) Patent Application Publication
(10) Pub. No.: US 2023/0100637 A1
(43) Pub. Date: Mar. 30, 2023

(54) BEAM UTILIZATION MANAGEMENT IN NON-TERRESTRIAL NETWORK COMMUNICATIONS

(71) Applicant: MediaTek Singapore Pte. Ltd., Singapore (SG)

(72) Inventors: Abdelkader MEDLES, Cambridge (GB); Gilles CHARBIT, Cambridge (GB)

(21) Appl. No.: 17/905,701

(22) PCT Filed: Mar. 5, 2021
(86) PCT No.: PCT/CN2021/079249

§ 371 Date: Sep. 6, 2022

Related U.S. Application Data
(60) Provisional application No. 62/986,864, filed on Mar. 9, 2020.

(51) Int. Cl. H04B 7/185; H04W 52/02

(52) U.S. Cl. CPC H04B 7/18513; H04W 52/0216

(57) ABSTRACT

Various solutions for beam utilization management in in non-terrestrial network (NTN) communications are described. An apparatus (e.g., a UE) obtains a duty cycle configuration with respect to a duty cycle of one or more beams of a set of beams of a cell in NTN communications. The apparatus then performs a task according to the duty cycle configuration.

### CROSS REFERENCE TO RELATED PATENT APPLICATION(S)

The present disclosure is part of a non-provisional application claiming the priority benefit of U.S. Patent Application No. 62/986,864, filed on 9 Mar. 2020, the content of which being incorporated by reference in its entirety.

### TECHNICAL FIELD

The present disclosure is generally related to mobile communications and, more particularly, to beam utilization management in non-terrestrial network (NTN) communications.

### BACKGROUND

Unless otherwise indicated herein, approaches described in this section are not prior art to the claims listed below and are not admitted as prior art by inclusion in this section.

In NTN communications, a satellite typically uses regional (and wide) beams to provide wide coverages with lower powers (and a lower carrier-to-noise (C/N) ratio). Moreover, the satellite typically uses local (and narrow) beams to provide local coverages with higher powers (and a higher C/N ratio). To achieve sufficient coverage, local beams are required. However, with respect local beams, there is an issue of how to balance the drawback of higher powers with the benefit of better coverage. Additionally, it is currently undefined regarding how networks and user equipment (UE) can perform non-connected tasks on the local beams. Therefore, there is a need for a solution to address aforementioned issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues. More specifically, various schemes proposed in the present disclosure pertain to beam utilization management in NTN communications and the UE configuration to use the radio resources. For instance, under various proposed schemes described herein, a UE may use local beam(s) only when necessary. Moreover, under various proposed schemes described herein, a UE and a network may perform one or more non-connected tasks on the local beams.

In one aspect, a method may involve an apparatus (e.g., a UE) obtaining a duty cycle configuration with respect to a duty cycle of one or more beams of a set of beams of a cell in NTN communications. The method may also involve the apparatus performing a task according to the duty cycle configuration.

In another aspect, a method may involve an apparatus (e.g., a network node) transmitting a duty cycle configuration with respect to a duty cycle of one or more beams of a set of beams of a cell in NTN communications. The method may also involve the apparatus exchanging data with a connected UE using a first beam of the set of beams outside an on-time of the duty cycle of the first beam.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT), Narrow Band Internet of Things (NB-IoT), Industrial Internet of Things (IIoT) and non-terrestrial network (NTN), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a block diagram of an example communication apparatus and an example network apparatus in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to beam utilization management in NTN communications. According to the present disclosure, a number of possible solutions may be implemented separately or jointly. That is, although these possible solutions may be described below separately, two or more of these possible solutions may be implemented in one combination or another.

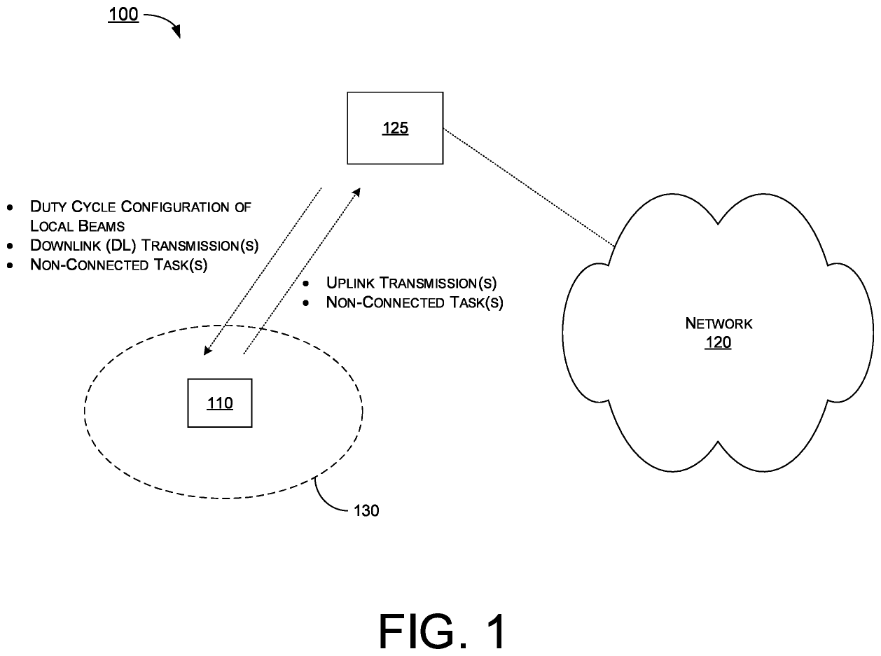

FIG. 1 illustrates an example network environment 100 in which various proposed schemes in accordance with the present disclosure may be implemented. Network environment 100 may involve a UE 110 and a wireless network 120 (e.g., an LTE network, a 5G network, an NR network, an IoT network, an NB-IoT network, an IIoT network or an NTN). UE 110 may communicate with wireless network 120 via a network node 125. In some cases, network node 125 may be a non-terrestrial (NT) network node (e.g., a satellite) of an NTN. In some cases, network node 125 may be a terrestrial network node (e.g., a base station (BS) such as a gNB, eNB or transmission/reception point (TRP)). Moreover, UE 110 may be located within a cell 130 when performing NTN communications. Each of UE 110 and network node 125 may be configured to perform operations pertaining to beam power management under various proposed schemes in accordance with the present disclosure, as described below.

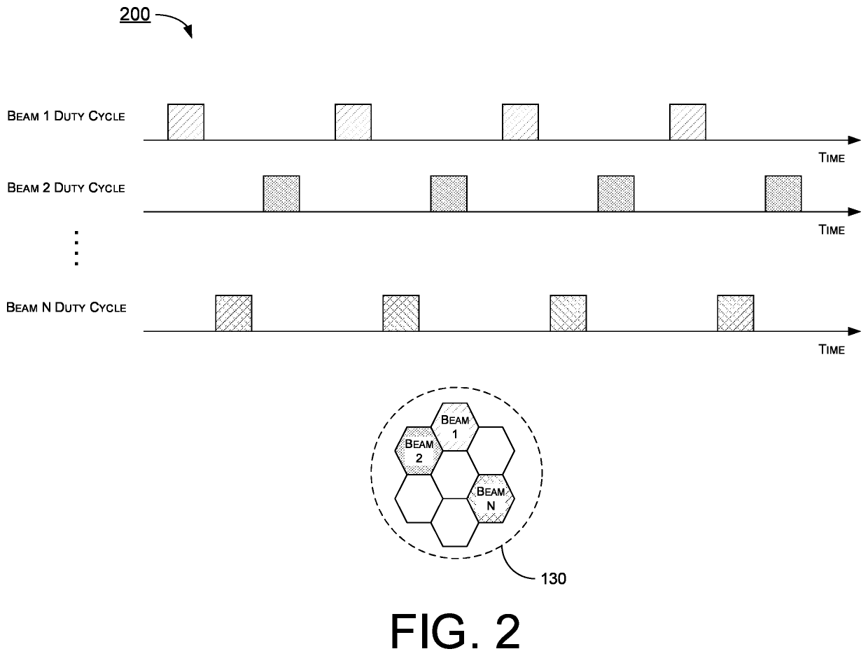

Under a proposed scheme in accordance with the present disclosure, with respect to local beams, beam periodic coverage with a duty cycle may be supported to allow UE 110 and network node 125 to perform non-connected tasks such as, for example and without limitation, initial cell access, paging, discontinuous reception (DRX) cycles, and/or cell reselection. FIG. 2 illustrates an example scenario 200 in accordance with an implementation of the present disclosure. Referring to FIG. 2, duty cycle for local beams may be used for UE 110 to be on for a certain period. Moreover, different beams may be interlaced to reduce interference between the local beams as well as to reduce power consumption on the part of UE 110. In scenario 200, duty cycles, on-times of duty cycles in particular, of local beam 1, local beam 2 . . . and local beam N (with N being an integer greater than 1) in cell 130 are shown to be interlaced.

Under a proposed scheme in accordance with the present disclosure, when UE 110 first acquires a cell, UE 110 may acquire a duty cycle configuration regarding one or more of the local beams. The duty cycle configuration may include some or all of the following pieces of information: (a) a periodicity of a duty transmit time, (b) an offset of the duty transmit time with respect to a reference time (e.g., a point in time when UE 110 acquired information of the duty cycle configuration, a global positioning system (GPS) time or the like), and (c) a duration of the duty transmit time. It is noteworthy that the periodicity, offset, and duration of the duty cycle may or may not differ from one local beam to another local beam. Under the proposed scheme, wireless network 120 may provide, and UE 110 may receive, the duty cycle configuration in one of several ways. For example, duty cycle configuration may be broadcasted as a part of a master information block (MIB) (e.g., an NB-IoT MIB usually has 10 spare bits which could be used for this purpose) or other system information block (SIB) or higher-layer signaling (e.g., radio resource control (RRC) signaling). As another example, duty cycle configuration may be pre-stored in a memory of UE 110 (e.g., stored in a subscriber identity module (SIM) of UE 110). As yet another example, duty cycle configuration may be from previously signaling acquired on neighbor cell(s). In an event that no configuration information is available to UE 110 before an initial search is performed by UE 110, UE 110 may wake up and search all possible duty cycle-related information and/or configurations. Accordingly, each of a plurality of UEs (including UE 110) may wake up only during the on-time, or on-period, of the duty cycle of one or more local beams of a cell according to the duty cycle configuration (e.g., for virtual cell services).

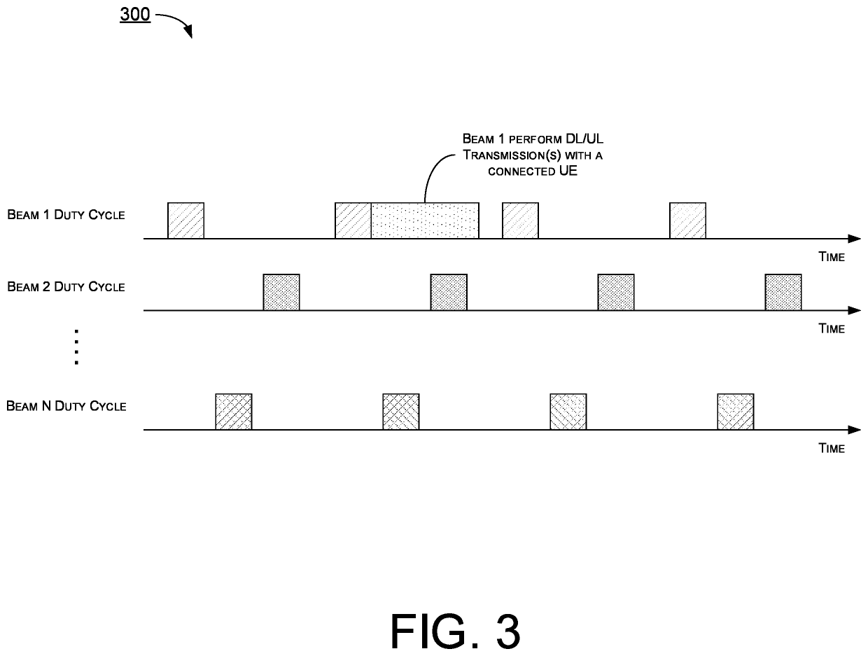

Under a proposed scheme in accordance with the present disclosure, when a local beam transmits to a connected UE (e.g., UE 110), the transmission may be performed outside of a respective duty cycle. FIG. 3 illustrates an example scenario 300 in accordance with an implementation of the present disclosure. Referring to FIG. 3, when there is downlink (DL) and/or uplink (UL) transmission to be performed in local beam 1, the DL/UL transmission(s) may be performed outside an ON period or ON time of the duty cycle configured for local beam 1. Under the proposed scheme, other beam transmissions during duty cycle may be kept to essential minimum in order to reduce interference and power consumption. In scenario 300, local beam 1 may be used to perform DL and/or UL transmission(s) between a satellite (e.g., network node 125 as an NT network node) and a connected UE (e.g., UE 110), and the DL/UL transmission(s) may be performed during and/or outside the configured on-time of the duty cycle of local beam 1. Moreover, during occurrence of the DL/UL transmission(s) in local beam 1, transmissions in other local beams (e.g., local beam 2 and local beam N) may be refrained, reduced or otherwise minimized to avoid interference on the DL/UL transmission(s) in local beam 1 and to lower power consumption on the part of UE 110.

### Illustrative Implementations

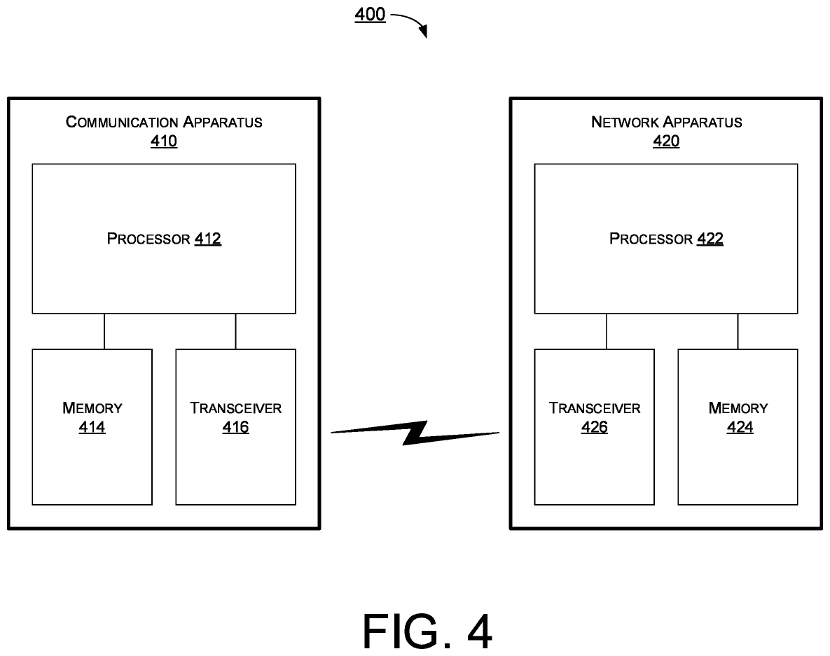

FIG. 4 illustrates an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to beam utilization management in NTN communications, including scenarios/schemes described above as well as processes 500 and 600 described below.

Communication apparatus 410 may be a part of an electronic apparatus, which may be a UE such as a portable or mobile apparatus, a wearable apparatus, a wireless communication apparatus or a computing apparatus. For instance, communication apparatus 410 may be implemented in a smartphone, a smartwatch, a personal digital assistant, a digital camera, or a computing equipment such as a tablet computer, a laptop computer or a notebook computer. Communication apparatus 410 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus/station, which may be a network node such as a base station, a small cell, a router, a gateway or a satellite. For instance, network apparatus 420 may be implemented in an eNodeB in an LTE, in a gNB in a 5G, NR, IoT, NB-IoT, IIoT, or in a satellite in an NTN network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including power consumption reduction in a device (e.g., as represented by communication apparatus 410) and a network (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

Each of communication apparatus 410 and network apparatus 420 may be a communication entity capable of communicating with each other using various proposed schemes in accordance with the present disclosure. To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE (e.g., UE 110) and network apparatus 420 is implemented in or as a network node or base station (e.g., network node 125) of a communication network (e.g., network 120). It is also noteworthy that, although the example implementations described below are provided in the context of WLAN, the same may be implemented in other types of networks.

Under a proposed scheme pertaining to beam utilization management in NTN communications in accordance with the present disclosure, with communication apparatus 410 implemented in or as UE 110 and network apparatus 420 implemented in or as network node 125 in network environment 100, processor 412 may obtain a duty cycle configuration with respect to a duty cycle of one or more beams of a set of beams of a cell in NTN communications. Additionally, processor 412 may perform, via transceiver 416, a task according to the duty cycle configuration.

In some implementations, the duty cycle configuration may indicate duty cycle information comprising at least one of: (a) a periodicity of a duty transmit time, (b) an offset of the duty transmit time, and (c) a duration of the duty transmit time.

In some implementations, on-times of duty cycles of the set of beams may be interlaced so that interference and power consumption with respect to apparatus 410 may be reduced.

In some implementations, in obtaining the duty cycle configuration, processor 412 may receive, via transceiver 416, the duty cycle configuration in an MIB broadcasted by a wireless network.

In some implementations, in obtaining the duty cycle configuration, processor 412 may receive, via transceiver 416, the duty cycle configuration in a SIB broadcasted by a wireless network.

In some implementations, in obtaining the duty cycle configuration, processor 412 may receive, via transceiver 416, the duty cycle configuration via an RRC signaling from a wireless network.

In some implementations, in obtaining the duty cycle configuration, processor 412 may retrieve the duty cycle configuration from a SIM of the apparatus.

In some implementations, in obtaining the duty cycle configuration, processor 412 may obtain the duty cycle configuration from a signaling previously received on a neighboring cell.

In some implementations, in performing the task according to the duty cycle configuration, processor 412 may perform certain operations. For instance, processor 412 may enter apparatus 410 into an operational mode to perform the task during an on-time of the duty cycle of at least one beam of the set of beams. Additionally, processor 412 may enter apparatus 410 into a low-power mode during an off-time of the duty cycle of the at least one beam of the set of beams.

In some implementations, in performing the task according to the duty cycle configuration, processor 412 may perform, via transceiver 416, a DL transmission or an UL transmission, or both, during an on-time of the duty cycle of at least one beam of the set of beams.

In some implementations, in performing the task according to the duty cycle configuration, processor 412 may perform, via transceiver 416, a DL transmission or an UL transmission, or both, outside an on-time of the duty cycle of at least one beam of the set of beams.

In some implementations, in performing the task according to the duty cycle configuration, processor 412 may perform, via transceiver 416, a non-connected task during an on-time of the duty cycle of at least one beam of the set of beams. In some implementations, the non-connected task may include at least one of the following: (1) initial cell access, (2) paging, (3) one or more DRX cycles, and (4) cell reselection.

In some implementations, processor 412 may perform additional operations. For instance, processor 412 may exchange, via transceiver 416, data with apparatus 420 as a network node (e.g., network node 125) of a wireless network (e.g., wireless network 120) using a first beam of the set of beams outside an on-time of the duty cycle of the first beam.

Under another proposed scheme pertaining to beam utilization management in NTN communications in accordance with the present disclosure, with communication apparatus 410 implemented in or as UE 110 and network apparatus 420 implemented in or as network node 125 in network environment 100, processor 422 may transmit, via transceiver 426, a duty cycle configuration with respect to a duty cycle of one or more beams of a set of beams of a cell in NTN communications. Additionally, processor 422 may exchange, via transceiver 426, data with apparatus 410 as a connected UE (e.g., UE 110) using a first beam of the set of beams outside an on-time of the duty cycle of the first beam.

In some implementations, the duty cycle configuration may indicate duty cycle information comprising at least one of: (a) a periodicity of a duty transmit time, (b) an offset of the duty transmit time, and (c) a duration of the duty transmit time.

In some implementations, in transmitting the duty cycle configuration, processor 422 may broadcast the duty cycle configuration in an MIB.

In some implementations, in transmitting the duty cycle configuration, processor 422 may broadcast the duty cycle configuration in a SIB.

In some implementations, in transmitting the duty cycle configuration, processor 422 may transmit the duty cycle configuration via an RRC signaling.

In some implementations, processor 422 may further perform, via transceiver 426, a DL transmission or an UL transmission, or both, during an on-time of the duty cycle of at least one beam of the set of beams.

In some implementations, processor 422 may further perform, via transceiver 426, a DL transmission or an UL transmission, or both, outside an on-time of the duty cycle of at least one beam of the set of beams.

In some implementations, processor 422 may perform, via transceiver 426, a non-connected task with apparatus 410 during an on-time of the duty cycle of at least one beam of the set of beams. In some implementations, the non-connected task may include at least one of the following: (1) initial cell access, (2) paging, (3) one or more DRX cycles, and (4) cell reselection.

### Illustrative Processes

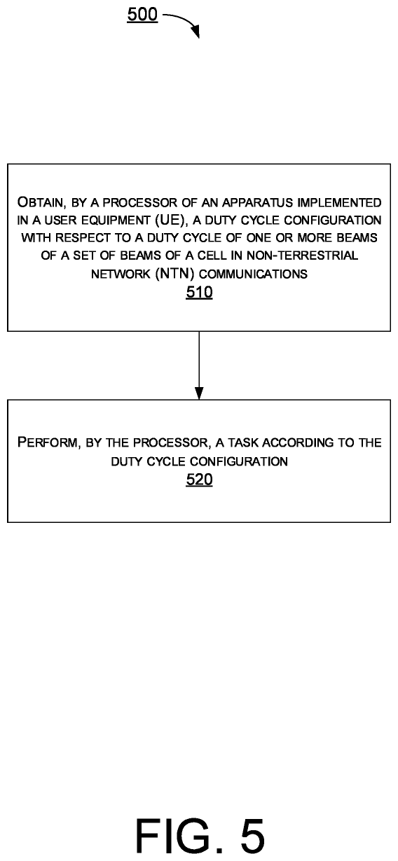

FIG. 5 illustrates an example process 500 in accordance with an implementation of the present disclosure. Process 500 may be an example implementation of schemes described above, whether partially or completely, with respect to beam utilization management in NTN communications in accordance with the present disclosure. Process 500 may represent an aspect of implementation of features of communication apparatus 410. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410 and network apparatus 420. Process 500 may begin at block 510.

At 510, process 500 may involve processor 412 of apparatus 410 (e.g., UE 110) obtaining a duty cycle configuration with respect to a duty cycle of one or more beams of a set of beams of a cell in NTN communications. Process 500 may proceed from 510 to 520.

At 520, process 500 may involve processor 412 performing, via transceiver 416, a task according to the duty cycle configuration.

In some implementations, the duty cycle configuration may indicate duty cycle information comprising at least one of: (a) a periodicity of a duty transmit time, (b) an offset of the duty transmit time, and (c) a duration of the duty transmit time.

In some implementations, on-times of duty cycles of the set of beams may be interlaced so that interference and power consumption with respect to apparatus 410 may be reduced.

In some implementations, in obtaining the duty cycle configuration, process 500 may involve processor 412 receiving, via transceiver 416, the duty cycle configuration in an MIB broadcasted by a wireless network.

In some implementations, in obtaining the duty cycle configuration, process 500 may involve processor 412 receiving, via transceiver 416, the duty cycle configuration in a SIB broadcasted by a wireless network.

In some implementations, in obtaining the duty cycle configuration, process 500 may involve processor 412 receiving, via transceiver 416, the duty cycle configuration via an RRC signaling from a wireless network.

In some implementations, in obtaining the duty cycle configuration, process 500 may involve processor 412 retrieving the duty cycle configuration from a SIM of the apparatus.

In some implementations, in obtaining the duty cycle configuration, process 500 may involve processor 412 obtaining the duty cycle configuration from a signaling previously received on a neighboring cell.

In some implementations, in performing the task according to the duty cycle configuration, process 500 may involve processor 412 performing certain operations. For instance, process 500 may involve processor 412 entering apparatus 410 into an operational mode to perform the task during an on-time of the duty cycle of at least one beam of the set of beams. Additionally, process 500 may involve processor 412 entering apparatus 410 into a low-power mode during an off-time of the duty cycle of the at least one beam of the set of beams.

In some implementations, in performing the task according to the duty cycle configuration, process 500 may involve processor 412 performing, via transceiver 416, a DL transmission or an UL transmission, or both, during an on-time of the duty cycle of at least one beam of the set of beams.

In some implementations, in performing the task according to the duty cycle configuration, process 500 may involve processor 412 performing, via transceiver 416, a DL transmission or an UL transmission, or both, outside an on-time of the duty cycle of at least one beam of the set of beams.

In some implementations, in performing the task according to the duty cycle configuration, process 500 may involve processor 412 performing, via transceiver 416, a non-connected task during an on-time of the duty cycle of at least one beam of the set of beams. In some implementations, the non-connected task may include at least one of the following: (1) initial cell access, (2) paging, (3) one or more DRX cycles, and (4) cell reselection.

In some implementations, process 500 may involve processor 412 performing additional operations. For instance, process 500 may involve processor 412 exchanging, via transceiver 416, data with apparatus 420 as a network node (e.g., network node 125) of a wireless network (e.g., wireless network 120) using a first beam of the set of beams outside an on-time of the duty cycle of the first beam.

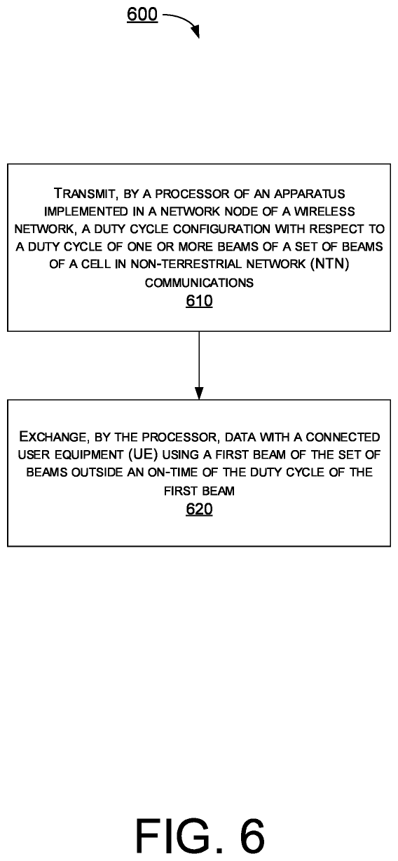

FIG. 6 illustrates an example process 600 in accordance with an implementation of the present disclosure. Process 600 may be an example implementation of schemes described above, whether partially or completely, with respect to beam utilization management in NTN communications in accordance with the present disclosure. Process 600 may represent an aspect of implementation of features of communication apparatus 410. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 410 or any suitable UE or machine type devices. Solely for illustrative purposes and without limitation, process 600 is described below in the context of communication apparatus 410 and network apparatus 420. Process 600 may begin at block 610.

At 610, process 600 may involve processor 422 of apparatus 420 (e.g., network node 125) transmitting, via transceiver 426, a duty cycle configuration with respect to a duty cycle of one or more beams of a set of beams of a cell in NTN communications. Process 600 may proceed from 610 to 620.

At 620, process 600 may involve processor 422 exchanging, via transceiver 426, data with apparatus 410 as a connected UE (e.g., UE 110) using a first beam of the set of beams outside an on-time of the duty cycle of the first beam.

In some implementations, the duty cycle configuration may indicate duty cycle information comprising at least one of: (a) a periodicity of a duty transmit time, (b) an offset of the duty transmit time, and (c) a duration of the duty transmit time.

In some implementations, in transmitting the duty cycle configuration, process 600 may involve processor 422 broadcasting the duty cycle configuration in an MIB.

In some implementations, in transmitting the duty cycle configuration, process 600 may involve processor 422 broadcasting the duty cycle configuration in a SIB.

In some implementations, in transmitting the duty cycle configuration, process 600 may involve processor 422 transmitting the duty cycle configuration via an RRC signaling.

In some implementations, process 600 may further involve processor 422 performing, via transceiver 426, a DL transmission or an UL transmission, or both, during an on-time of the duty cycle of at least one beam of the set of beams.

In some implementations, process 600 may further involve processor 422 performing, via transceiver 426, a DL transmission or an UL transmission, or both, outside an on-time of the duty cycle of at least one beam of the set of beams.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

1. A method, comprising:
obtaining, by a processor of an apparatus implemented in a user equipment (UE), a duty cycle configuration with respect to a duty cycle of one or more beams of a set of beams of a cell in non-terrestrial network (NTN) communications; and
performing, by the processor, a task according to the duty cycle configuration.

2. The method of claim 1, wherein the duty cycle configuration indicates duty cycle information comprising at least one of:
a periodicity of a duty transmit time,
an offset of the duty transmit time, and
a duration of the duty transmit time.

3. The method of claim 1, wherein on-times of duty cycles of the set of beams are interlaced.

4. The method of claim 1, wherein the obtaining of the duty cycle configuration comprises receiving the duty cycle configuration in a master information block (MIB) broadcasted by a wireless network.

5. The method of claim 1, wherein the obtaining of the duty cycle configuration comprises receiving the duty cycle configuration in a system information block (SIB) broadcasted by a wireless network.

6. The method of claim 1, wherein the obtaining of the duty cycle configuration comprises receiving the duty cycle configuration via a radio resource control (RRC) signaling from a wireless network.

7. The method of claim 1, wherein the obtaining of the duty cycle configuration comprises retrieving the duty cycle configuration from a subscriber identity module (SIM) of the apparatus.

8. The method of claim 1, wherein the obtaining of the duty cycle configuration comprises obtaining the duty cycle configuration from a signaling previously received on a neighboring cell.

9. The method of claim 1, wherein the performing of the task according to the duty cycle configuration comprises:
entering the apparatus into an operational mode to perform the task during an on-time of the duty cycle of at least one beam of the set of beams; and
entering the apparatus into a low-power mode during an off-time of the duty cycle of the at least one beam of the set of beams.

10. The method of claim 1, wherein the performing of the task according to the duty cycle configuration comprises performing a downlink (DL) transmission or an uplink (UL) transmission, or both, during an on-time of the duty cycle of at least one beam of the set of beams.

11. The method of claim 1, wherein the performing of the task according to the duty cycle configuration comprises performing a downlink (DL) transmission or an uplink (UL) transmission, or both, outside an on-time of the duty cycle of at least one beam of the set of beams.

12. The method of claim 1, wherein the performing of the task according to the duty cycle configuration comprises performing a non-connected task during an on-time of the duty cycle of at least one beam of the set of beams.

13. The method of claim 12, wherein the non-connected task comprises at least one of:
initial cell access,
paging,
a discontinuous reception (DRX) cycle, and
cell reselection.

14. The method of claim 1, further comprising:
exchanging, by the processor, data with a network node of a wireless network using a first beam of the set of beams outside an on-time of the duty cycle of the first beam.

15. A method, comprising:
transmitting, by a processor of an apparatus implemented in a network node of a wireless network, a duty cycle configuration with respect to a duty cycle of one or more beams of a set of beams of a cell in non-terrestrial network (NTN) communications; and
exchanging, by the processor, data with a connected user equipment (UE) using a first beam of the set of beams outside an on-time of the duty cycle of the first beam.

16. The method of claim 15, wherein the duty cycle configuration indicates duty cycle information comprising at least one of:
a periodicity of a duty transmit time,
an offset of the duty transmit time, and
a duration of the duty transmit time.

17. The method of claim 15, wherein the transmitting of the duty cycle configuration comprises broadcasting the duty cycle configuration in a master information block (MIB).

18. The method of claim 15, wherein the transmitting of the duty cycle configuration comprises broadcasting the duty cycle configuration in a system information block (SIB).

19. The method of claim 15, wherein the transmitting of the duty cycle configuration comprises transmitting the duty cycle configuration via a radio resource control (RRC) signaling.

20. The method of claim 15, further comprising:
performing, by the processor, a downlink (DL) transmission or an uplink (UL) transmission, or both, outside an on-time of the duty cycle of at least one beam of the set of beams.
